(19) United States
(12) Patent Application Publication
(10) Pub. No.: US 2019/0223244 A1
(43) Pub. Date: Jul. 18, 2019

(54) METHOD FOR AVOIDING ESTABLISHING AN INEFFICIENT WIRELESS CONNECTION AND A COMMUNICATIONS APPARATUS UTILIZING THE SAME

(71) Applicant: MEDIATEK INC., Hsin-Chu (TW)

(72) Inventors: Sheng-Hung LAI, New Taipei City (TW); Wei-Hsuan LIEN, Taipei (TW); Chun-Wei TSENG, Taipei City (TW); Ya-Ti HAO, Taipei City (TW)

(21) Appl. No.: 15/869,714

(22) Filed: Jan. 12, 2018

(51) Int. Cl. H04W 76/16; H04W 72/08; H04W 36/16; H04W 36/24; H04W 36/30

(52) U.S. Cl. CPC H04W 76/16; H04W 72/08; H04W 36/30; H04W 36/245; H04W 36/165

(57) ABSTRACT

A method for avoiding establishing an inefficient wireless connection for a communications apparatus capable of supporting cellular communications and WLAN communications includes: receiving a beacon frame from a first network device, wherein the first network device is a WLAN network device which provides wireless communications service in a predetermined wireless local area network; identifying the first network device according to an identifier obtained from the beacon frame; determining whether to connect to the first network device according to a connectivity record of the first network device or a usage scenario of the communications apparatus; and not connecting to the first network device if a WLAN connection to be established with the first network device is determined as an inefficient connection.

### BACKGROUND OF THE INVENTION

### Field of the Invention

The invention relates to methods for avoiding establishing an establishing inefficient wireless connection for a communications apparatus.

### Description of the Related Art

The term “wireless” normally refers to an electrical or electronic operation, which is accomplished without the use of a “hard wired” connection. “Wireless communications” is the transfer of information over a distance without the use of electrical conductors or wires. The distances involved may be short (a few meters for television remote controls) or very long (thousands or even millions of kilometers for radio communications). The best known example of wireless communications is the cellular telephone. Cellular telephones use radio waves to enable an operator to make phone calls to another party from many locations worldwide. They can be used anywhere, as long as there is a cellular telephone site to house equipment that can transmit and receive signals, which are processed to transfer both voice and data to and from the cellular telephones.

There are various well-developed and well-defined cellular communications technologies. For example, the Global System for Mobile communications (GSM) is a well-defined and commonly used communications system, which uses time division multiple access (TDMA) technology, which is a multiplex access scheme for digital radio, to send voice, data, and signaling data (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Wireless Fidelity (Wi-Fi) is a technology defined by the 802.11 engineering standard and can be used for home networks, mobile phones, and video games to provide a high-frequency wireless local area network. Long-Term Evolution (LTE) is a standard for wireless communication of high-speed data for mobile phones and data terminals. It is based on the GSM/EDGE and UMTS/HSPA network technologies, increasing the capacity and speed using a different radio interface together with core network improvements.

In order to provide more efficient communications services and improve user experience, methods for avoiding establishing an inefficient wireless connection for a communications apparatus are provided.

### BRIEF SUMMARY OF THE INVENTION

A communications apparatus and methods for avoiding establishing an inefficient wireless connection are provided. An exemplary embodiment of a communications apparatus capable of supporting cellular communications and WLAN communications comprises a radio transceiver and a processor. The radio transceiver is configured to receive a beacon frame from a first network device. The first network device is a WLAN network device which provides wireless communications service in a predetermined wireless local area network. The processor is configured to identify the first network device according to an identifier obtained from the beacon frame, and determine whether to connect to the first network device according to a connectivity record of the first network device or a usage scenario of the communications apparatus. When the processor determines that a WLAN connection to be established with the first network device will be an inefficient connection, the processor determines not to connect to the first network device.

An exemplary embodiment of a method for avoiding establishing an inefficient wireless connection for a communications apparatus capable of supporting cellular communications and WLAN communications includes: receiving a beacon frame from a first network device, wherein the first network device is a WLAN network device which provides wireless communications service in a predetermined wireless local area network; identifying the first network device according to an identifier obtained from the beacon frame; determining whether to connect to the first network device according to a connectivity record of the first network device or a usage scenario of the communications apparatus; and not connecting to the first network device if a WLAN connection to be established with the first network device is determined as an inefficient connection.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary block diagram of a communications apparatus according to an embodiment of the invention;

FIG. 2 shows an exemplary message flow in an authentication procedure and association procedure performed by a mobile device and a WLAN network device;

FIG. 3 shows an exemplary flow chart of a method for avoiding establishing an inefficient wireless connection according to an embodiment of the invention;

FIG. 4 is an exemplary diagram showing the determination procedure according to an embodiment of the invention; and

FIG. 5 is an exemplary diagram showing the scores calculated by the WLAN connection decision engine in a connectivity service.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

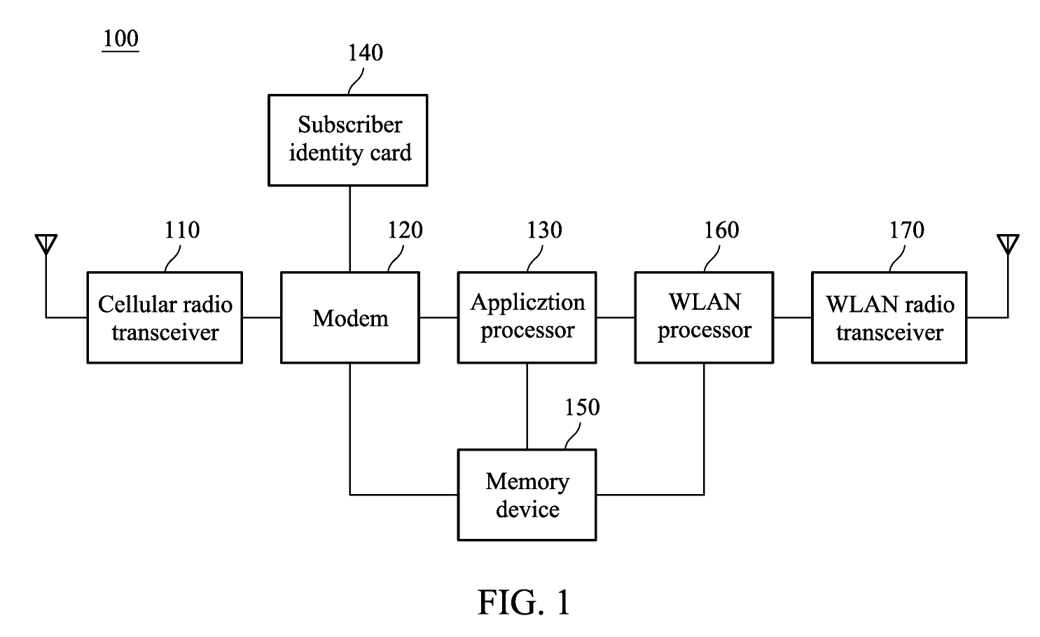

FIG. 1 shows an exemplary block diagram of a communications apparatus according to an embodiment of the invention. The communications apparatus 100 may be a portable electronic device or a mobile device, such as a Mobile Station (MS, which may be interchangeably referred to as User Equipment (UE)), and is capable of supporting cellular communications and wireless local area network (WLAN) communications. The communications apparatus 100 may comprise one or more antenna modules, wherein each antenna module may comprise one or more antennas, a cellular radio transceiver 110, a modem 120, an application processor 130, a subscriber identity card 140, a memory device, 150, a WLAN processor 160 and a WLAN radio transceiver 170. The cellular radio transceiver 110 may receive wireless radio frequency signals from an air interface via the corresponding antenna module, transmit wireless radio frequency signals to the air interface via the corresponding antenna module and perform RF signal processing. For example, the cellular radio transceiver 110 may convert the received signals into intermediate frequency (IF) or baseband signals to be processed, or receive the IF or baseband signals from the modem 120 and convert the received signals into wireless radio frequency signals to be transmitted to a cellular network device. According to an embodiment of the invention, the cellular network device may be a cell, an evolved node B, a base station, a Mobility Management Entity (MME) etc., at the cellular network side and communicating with the communications apparatus 100 via the wireless radio frequency signals.

The cellular radio transceiver 110 may comprise a plurality of hardware devices to perform radio frequency conversion and RF signal processing. For example, the cellular radio transceiver 110 may comprise a power amplifier for amplifying the RF signals, a filter for filtering unwanted portions of the RF signals and/or a mixer for performing radio frequency conversion. According to an embodiment of the invention, the radio frequency may be, for example, the frequency of any specific frequency band for a Long-Term Evolution (LTE) system, etc.

The modem 120 may be a cellular communications modem configured for handling cellular system communications protocol operations and processing the IF or baseband signals received from or to be transmitted to the cellular radio transceiver 110. The modem 120 may comprise at least a baseband processing device, a processor and an internal memory device. The baseband processing device may receive the IF or baseband signals from the cellular radio transceiver 110 and perform IF or baseband signal processing. For example, the baseband processing device may convert the IF or baseband signals into a plurality of digital signals, and process the digital signals, and vice versa. The baseband processing device may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, a encoder for signal encoding, a decoder for signal decoding, and so on.

The processor in the modem 120 may control the operations of the modem 120. According to an embodiment of the invention, the processor may be arranged to execute the program codes of the corresponding software module of the modem 120. The processor may maintain and execute the individual tasks, threads, and/or protocol stacks for different software modules.

The processor may also read data from the subscriber identity card 140 coupled to the modem 120, and write data to the subscriber identity card 140. The internal memory device in the modem 120 may store system data and user data for the modem 120. The processor may also access the internal memory device.

It should be noted that in some embodiments of the invention, the baseband processing device and the processor in the modem 120 may be integrated into one processing unit, and the modem may comprise one or more multiple such processing units, for supporting multi-RAT operations.

The application processor 130 is configured for running the operating system of the communications apparatus 100 and running application programs installed in the communications apparatus 100. The application processor 130 may further have some processing or computation abilities, such as multimedia data encoding/decoding, audio signal processing, interface connectivity, digital signal processing, or others.

In the embodiments of the invention, the modem 120 and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like and may typically contain user account information, an International Mobile Subscriber Identity (IMSI) and a set of SIM application toolkit (SAT) commands and may provide storage space for phone book contacts. The memory device 150 may be coupled to the modem 120, the application processor 130 and the WLAN processor 160 and may store system data or user data.

The WLAN radio transceiver 170 may receive wireless radio frequency signals from an air interface via the corresponding antenna module, transmit wireless radio frequency signals to the air interface via the corresponding antenna module and perform RF signal processing. For example, the WLAN radio transceiver 170 may convert the received signals into intermediate frequency (IF) or baseband signals to be processed, or receive the IF or baseband signals from the WLAN processor 140 and convert the received signals into wireless radio frequency signals to be transmitted to a WLAN network device. According to an embodiment of the invention, the WLAN network device may be a Wi-Fi hot-spot, a Wi-Fi access point, or any network device providing ISM band communications services in a wireless local area network and communicating with the communications apparatus 100 via the wireless radio frequency signals.

The WLAN radio transceiver 170 may comprise a plurality of hardware devices to perform radio frequency conversion and RF signal processing. For example, the WLAN radio transceiver 170 may comprise a power amplifier for amplifying the RF signals, a filter for filtering unwanted portions of the RF signals and/or a mixer for performing radio frequency conversion.

The WLAN processor 160 may receive the IF or baseband signals from the WLAN radio transceiver 170 and perform IF or baseband signal processing. The WLAN processor 160 may further execute the program codes of the corresponding software module to implement WLAN protocol and support WLAN protocol computations. The WLAN protocol may be defined in the Wi-Fi standards, the 802.11 series of standards, or the like.

The WLAN processor 160 is coupled to the application processor 130 of the communications apparatus 100. The application processor 130 may control the cooperation of the cellular communications and the WLAN communications for the communications apparatus 100.

It should be noted that, in order to clarify the concept of the invention, FIG. 1 presents a simplified block diagram in which only the elements relevant to the invention are shown. For example, in some embodiments of the invention, the communications apparatus may further comprise some peripheral devices not shown in FIG. 1.

It should be noted that, although FIG. 1 shows a single-card single-standby application, the invention should not be limited thereto. For example, in some embodiments of the invention, the communications apparatus may comprise multiple subscriber identity cards to support multiple radio access technologies (RATs) communications. In the multiple RATs communications applications, the modem, the cellular radio transceiver and/or the antenna module may be shared by the subscriber identity cards and may have the capability of handling the operations of multiple cellular system communications protocols and processing the corresponding RF, IF or baseband signals in compliance with multiple cellular system communications protocols. Those who are skilled in this technology can still make various alterations and modifications based on the descriptions given above to derive the communications apparatuses comprising multiple cellular radio transceivers and/or multiple antenna modules for supporting multiple RAT wireless communications without departing from the scope and spirit of this invention. Therefore, in some embodiments of the invention, the communications apparatus may be designed to support a multi-card multi-standby application by making some alterations and modifications.

It should be noted that the subscriber identity card 140 may be dedicated hardware cards as described above, or in some embodiments of the invention, there may be individual identifiers, numbers, addresses, or the like which are burned in the internal memory device of the corresponding modem and are capable of identifying the communications apparatus. Therefore, the invention should not be limited to what is shown in the figures.

In the existing design, when a mobile device receives a beacon frame from a WLAN network device and identifies the WLAN network device, the mobile device is directly connected to the WLAN network device (for example, by performing an authentication procedure and an association procedure). In this manner, the mobile data communications service will be provided by the newly established WLAN connection instead of the previously established cellular connection. The mobile device may also trigger a detach procedure to detach the data communications service from a previously established cellular connection of a cellular network device, so that the data traffic will be carried out through the WLAN connection. The reason to use the WLAN connection instead of the cellular connection for data communications is that the WLAN connection is usually free from charge. Therefore, the data communications through the WLAN connection link will be benefit to the mobile device user.

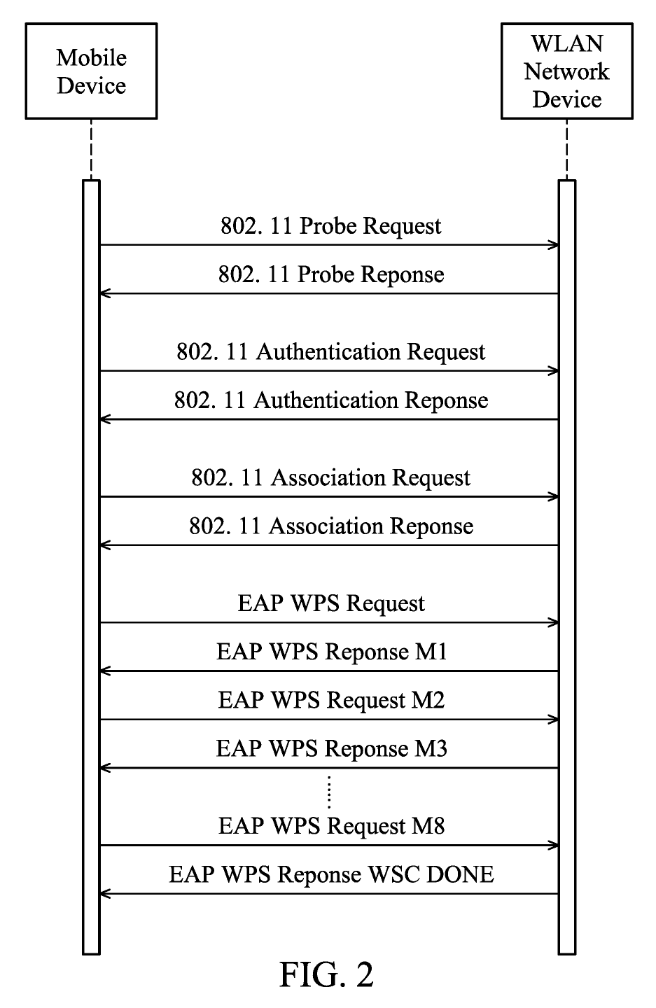

FIG. 2 shows an exemplary message flow in an authentication procedure and association procedure performed by a mobile device and a WLAN network device. After the authentication procedure and the association procedure, an identification procedure begins and the Wi-Fi Protected Setup (WPS) is requested. After the procedures, the encryption keys (such as the pre-shared key (PSK) corresponding to the WLAN network device will be obtained.

The mobile device generally stores the encryption keys corresponding to the WLAN network device that the mobile device has connected to (or, associated with). In this manner, the mobile device can identify the WLAN network device next time when receiving the beacon frame from that WLAN network device.

Because the mobile device is usually directly connected to the WLAN network device if the WLAN network device sending the beacon frame can be recognized, this raises some problems in the existing design. For example, when the user of the mobile device is riding on the Mass Rapid Transit (MRT) train, or another subway system, and the MRT train stops at a station for a short time, if the mobile device ends the original cellular connection for data communications and connects directly to the WLAN network device detected in that station, this WLAN connection can only be maintained for a very short time and will be dropped as the train leaves the station. In this manner, the connection will be ended and the data communications will be dropped again. Such intermittent connection will lead to poor user experience. In addition, undesired power consumption and network access latency generated when the mobile device repeatedly performs the connection establishment procedures in a short time will also cause user experience to suffer. Here, the network access latency may refer to the period of time after a procedure to connect to a network device has been triggered and before the connection has been successfully established. During this period of time, because the connection has not been successfully established, the user is unable to use the communications service.

To solve this problem and to provide more efficient communications services and improve user experience, methods for avoiding establishing an inefficient wireless connection for a communications apparatus are provided.

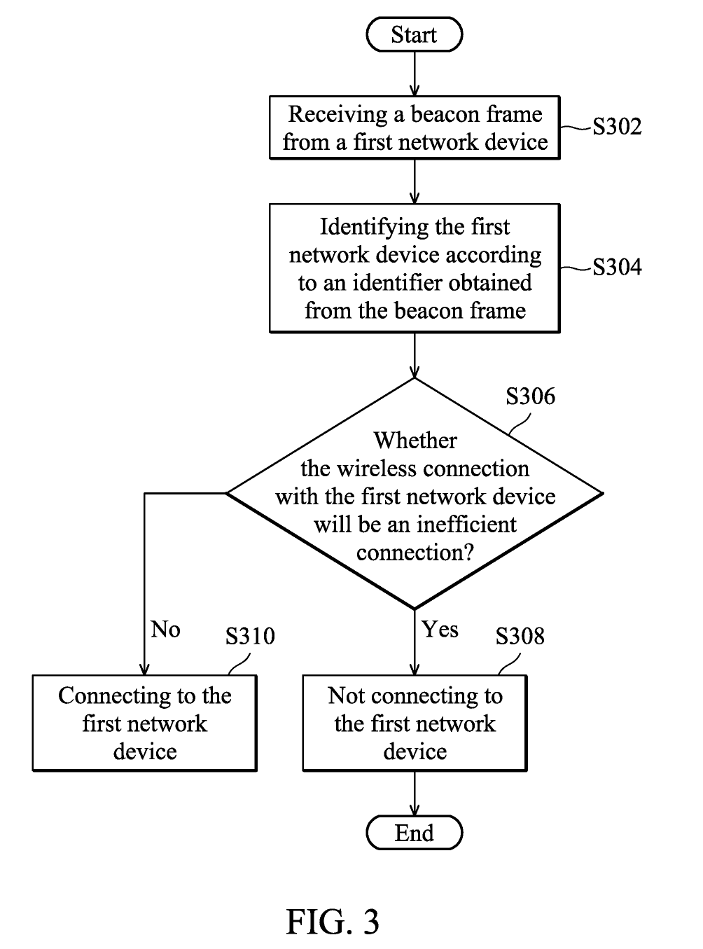

FIG. 3 shows an exemplary flow chart of a method for avoiding establishing an inefficient wireless connection according to an embodiment of the invention. First of all, the radio transceiver (e.g. the WLAN radio transceiver 170) receives a beacon frame from a first network device (Step S302). The first network device is a WLAN network device providing wireless communications service in a predetermined wireless local area network. Next, the processor (e.g. the WLAN processor 160 or the application processor 130) obtains an identifier of the first network device and identifies the first network device according to the identifier obtained from the beacon frame (Step S304). According to an embodiment of the invention, the identifier obtained from the beacon frame may be the Service Set Identifier (SSID) of the first network device. The processor (e.g. the WLAN processor 160 or the application processor 130) may further identify the first network device based on the encryption keys corresponding to the identifier. When the SSID and the encryption keys corresponding to the SSID of the first network device have been stored in the memory (e.g. the memory device 150 or an internal memory device the processor), it means that the communications apparatus 100 has, in the past, successfully established a wireless connection with the first network device at least once.

After the first network device has been identified, the processor (e.g. the WLAN processor 160 or the application processor 130) may determine whether to connect to the first network device according to the connectivity record of the first network device or the usage scenario of the communications apparatus. The concept of the determination is to determine whether a wireless connection to be established with the first network device will be an inefficient connection or not (Step S306). In the embodiments of the invention, an inefficient connection may refer to a connection which will probably be successfully established or last for only a short time (shorter than a predetermined time threshold), a connection which will probably have limited data throughput (lower than a predetermined throughput threshold), a connection which will probably have a limited connection quality (poorer than a predetermined quality threshold), a connection which will probably cause a long network access latency (longer than a predetermined network access latency threshold), a connection which will probably cause a huge power consumption (more than a predetermined power consumption threshold), a connection which is probably unable to be successfully established, or others. Details of the determination are discussed further in the following paragraphs.

When it is determined that the WLAN connection to be established with the first network device will be an inefficient connection, the processor (e.g. the WLAN processor 160 or the application processor 130) determines not to connect to the first network device (Step S308). To be more specific, if the determination is made by the application processor 130, the application processor 130 may further instruct the WLAN processor 160 not to connect to the first network device, even if the communications apparatus 100 can recognize the first network device and the corresponding encryption keys associated with the first network device is known (have been stored) by the communications apparatus 100. That is, even if the communications apparatus 100 has the ability to directly and automatically connect to the first network device, the communications apparatus 100 will still not connect to it.

Furthermore, if there is a cellular connection that has already been established with a cellular network device before receiving the beacon frame from the first network device, the processor (e.g. the application processor 130) may determine not to end this cellular connection and maintain the cellular connection with the cellular network device. That is, the communications apparatus 100 will keep using the data communications service provided by the cellular network device, and the future data transmission will still be carried out through the cellular connection.

On the other hand, if it is determined that the WLAN connection to be established with the first network device is not an inefficient connection, the processor (e.g. the WLAN processor 160 or the application processor 130) may determine to connect to the first network device (Step S310). Furthermore, if there is a cellular connection that has already been established with a cellular network device before receiving the beacon frame from the first network device, the processor (e.g. the application processor 130) may determine to end this cellular connection. For example, the processor may trigger a detach procedure to detach the data communications service from the cellular network device, and the data transmission will be carried out through the WLAN connection. Note that the processor may also not trigger the detach procedure, but still carry out the data transmission through the WLAN connection. Therefore, the embodiments are not limited to any specific implementation method.

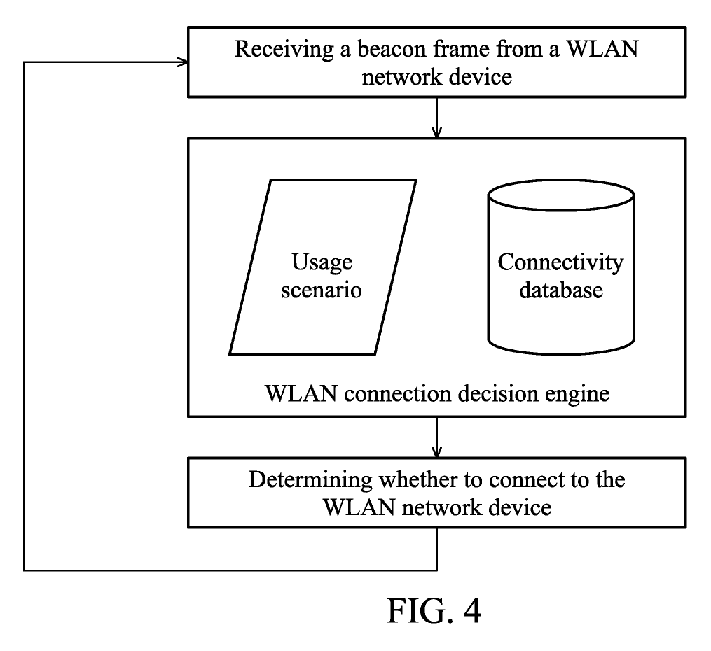

FIG. 4 is an exemplary diagram showing the determination procedure according to an embodiment of the invention. Upon receiving a beacon frame from a WLAN network device, a WLAN connection decision engine may check the current usage scenario of the communications apparatus 100 and/or the connectivity record of the corresponding WLAN network device in a connectivity database. The WLAN connection decision engine may be located inside of the WLAN processor 160 or the application processor 130, or may be located in a cloud server. Then, the WLAN connection decision engine may determine whether to connect to the WLAN network device. The determination procedure may be triggered every time a beacon frame is received, or when a beacon frame is received as a cellular connection exists (that is, has been successfully established and can be used).

According to an embodiment of the invention, the WLAN connection decision engine may score the WLAN connection to be established with the WLAN network device and determine whether the WLAN connection is an inefficient connection. When the score of the WLAN connection is higher than a predetermined threshold, the WLAN connection may be determined to be an efficient connection, and the WLAN connection decision engine may determine to connect to the WLAN network device. When the score of the WLAN connection is not higher than the predetermined threshold, the WLAN connection may be determined to be an inefficient connection, and the WLAN connection decision engine may determine not to connect to the WLAN network device.

According to an embodiment of the invention, the usage scenario may be determined according to the moving speed of the communications apparatus 100. Detections or measurements of the moving speed may be performed by a GPS receiver of the communications apparatus 100 (not shown), a G sensor of the communications apparatus 100 (not shown), or the processor (for example, the processor of the modem 120 or the application processor 130). When the moving speed of the communications apparatus 100 is higher than a predetermined speed, it means that the communications apparatus 100 may soon leave the coverage area of the WLAN network device. In this manner, the WLAN connection decision engine may decrease the score of the WLAN connection or give a relatively low score to the WLAN connection.

On the other hand, when the moving speed of the communications apparatus 100 is not higher than a predetermined speed, it means that the communications apparatus 100 may not soon leave the coverage area of the WLAN network device. In this manner, the WLAN connection decision engine may increase the score of the WLAN connection or give a relatively high score to the WLAN connection. Here, the relatively high or low score may refer to a score which is higher or lower than a cellular connection, or a score which will possibly trigger the WLAN connection decision engine to determine to connect or not connect to the corresponding WLAN network device.

According to another embodiment of the invention, the usage scenario may be determined according to the data throughput of a current cellular connection, a data length of the data to be transmitted or has been transmitted via a current cellular connection, a time span between two successive data packets transmitted via a current cellular connection, a frequency to trigger successive data transmissions via a current cellular connection, or others. When the data throughput, the data length of the current cellular connection or the frequency to trigger successive data transmissions is higher than a predetermined threshold, or the time span between two successive data packets is shorter than a predetermined threshold, it means that the user now requires a great amount of data transmission. In this manner, the WLAN connection decision engine may give a relatively high or a relatively low score to the WLAN connection, depending on different design requirements. For example, the WLAN connection decision engine may determine the score by further considering a combination of one or more of the following factors: the moving speed of the communications apparatus 100, the data throughput previously recorded or the average data throughput with respect to the WLAN network device, or others.

As an example, if the data throughput or the data length of the current cellular connection is high and the moving speed is also high, the WLAN connection decision engine may decrease the score of the WLAN connection or give a relatively low score to the WLAN connection. In another example, if the data throughput or the data length of the current cellular connection is high and the data throughput previously recorded or the average data throughput with respect to the WLAN network device is high, the WLAN connection decision engine may increase the score of the WLAN connection or give a relatively high score to the WLAN connection.

According to another embodiment of the invention, a connectivity database stored in the memory (e.g. the memory device 150 or an internal memory device the processor) and may record the connectivity information regarding different network devices (which can be either a cellular network device or a WLAN network device). As an example, each connectivity record may be linked to a MAC address or a BSSID of the network device. The connectivity information may comprise the connection time of a previous connection measured when the communications apparatus 100 previously connected to the network device or an average connection time of the connections previously established with the network device.

As an example, if the connection time or the average connection time recorded in the connectivity record of the WLAN network device is shorter than a predetermined threshold, the WLAN connection decision engine may decrease the score of the WLAN connection or give a relatively low score to the WLAN connection. When the connection time or the average connection time of the WLAN network device is not shorter than a predetermined threshold, the WLAN connection decision engine may increase the score of the WLAN connection or give a relatively high score to the WLAN connection.

According to another embodiment of the invention, the connectivity information may also comprise the data throughput of a previous connection measured when the communications apparatus previously connected to the network device or an average data throughput of the connections previously established with the network device.

As an example, if the data throughput or the average data throughput recorded in the connectivity record of the WLAN network device is lower than a predetermined threshold, the WLAN connection decision engine may decrease the score of the WLAN connection or give a relatively low score to the WLAN connection. When the data throughput or the average data throughput of the WLAN network device is not lower than a predetermined threshold, the WLAN connection decision engine may increase the score of the WLAN connection or give a relatively high score to the WLAN connection.

According to another embodiment of the invention, the connectivity information may also comprise the connection quality of a previous connection measured when the communications apparatus previously connected to the network device or an average connection quality of the connections previously established with the network device. Note that in the embodiments of the invention, the connection quality may be determined according to a latency of receiving an ACK from the network device, or a signal quality, an SNR or any other quality factors regarding the communications services provided by the network device.

As an example, if the connection quality or the average connection quality recorded in the connectivity record of the WLAN network device is lower than a predetermined threshold, the WLAN connection decision engine may decrease the score of the WLAN connection or give a relatively low score to the WLAN connection. When the connection quality or the average connection quality of the WLAN network device is not lower than a predetermined threshold, the WLAN connection decision engine may increase the score of the WLAN connection or give a relatively high score to the WLAN connection.

According to another embodiment of the invention, the connectivity information may also comprise a network access latency of a previous connection measured when the communications apparatus previously connected to the network device or an average network access latency of the connections previously established with the network device.

As an example, if the network access latency or the average network access latency recorded in the connectivity record of the WLAN network device is longer than a predetermined threshold, the WLAN connection decision engine may decrease the score of the WLAN connection or give a relatively low score to the WLAN connection. When the network access latency or the average network access latency of the WLAN network device is not longer than a predetermined threshold, the WLAN connection decision engine may increase the score of the WLAN connection or give a relatively high score to the WLAN connection.

According to another embodiment of the invention, the connectivity information may also comprise a power consumption required to connect to the network device for a previous connection measured when the communications apparatus previously connected to the network device or an average power consumption required for the connections previously established with the network device.

As an example, if the power consumption or the average power consumption recorded in the connectivity record of the WLAN network device is greater than a predetermined threshold, the WLAN connection decision engine may decrease the score of the WLAN connection or give a relatively low score to the WLAN connection. When the power consumption or the average power consumption of the WLAN network device is not greater than a predetermined threshold, the WLAN connection decision engine may increase the score of the WLAN connection or give a relatively high score to the WLAN connection.

According to another embodiment of the invention, the connectivity information may also comprise a connection time, a data throughput, or other factors as discussed above of a previous connection measured when the communications apparatus 100 previously connected to a second network device while the communications apparatus 100 is also in the coverage area of a first network device, or an average connection time, data throughput, or others of the connections previously established with the second network device while the communications apparatus 100 is in the coverage area of the first network device.

In other words, the connectivity information when the communications apparatus 100 is in the coverage area of a first network device but connects to the second network device may also be recorded in the connectivity record of the first network device. As an example, if the connection time or average connection time, or the data throughput or average data throughput when the communications apparatus 100 previously connected to a cellular network device while the communications apparatus 100 is also in the coverage area of a WLAN network device is longer or greater than a predetermined threshold, the WLAN connection decision engine may decrease or increase the score of the WLAN connection or give a relatively low or high score to the WLAN connection, depending on different design requirements or different combinations of the factors.

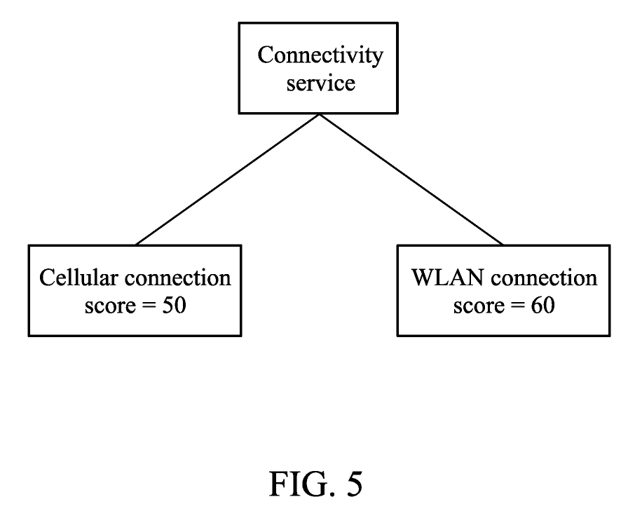

FIG. 5 is an exemplary diagram showing the scores calculated by the WLAN connection decision engine in a connectivity service. In the embodiments of the invention, the WLAN connection score and the Cellular connection score may be determined based on one or any combinations of the factors as discussed above. The factors utilized to determine the scores may be flexibly selected, so as to facilitate the processor to precisely determine whether the WLAN connection to be established will be an inefficient connection or not. As shown in FIG. 5, if the final WLAN connection score is higher than the cellular connection score, the processor may determine to connect to the WLAN network device. When the final WLAN connection score is lower than the cellular connection score, the processor determines not to connect to the WLAN network device.

Different from the existing design, in which a mobile device is directly connected to a WLAN network device when the mobile device receives a beacon frame from the WLAN network device and finds that it can recognize the WLAN network device, in the embodiments of the invention, the communications apparatus or mobile device may not directly connect to the WLAN network device. In this manner, if the WLAN connection to be established will be an inefficient connection, poor user experience due to inefficient connection can be avoided.

Note that in some embodiments of the invention, the final decision of whether to connect to the WLAN network device may also be made by the user. For example, if the processor determines that the WLAN connection to be established will be an inefficient connection, a popup message window may be shown on the screen of the communications apparatus 100 to query the user as to whether to connect to the WLAN network device. Such behavior is still different from the existing design since there is neither a determination of whether the WLAN connection to be established will be an inefficient connection, nor a query to the user implemented in the existing design.

In addition, in some embodiments, if the processor can identify and recognize a WLAN network device based on its SSID, but the connectivity record linked to the MAC address or the BSSID of the WLAN network device is not stored in the connectivity database, the behavior of the communications apparatus 100 may still be different from the existing design. As an example, the processor may determine whether to connect to the current WLAN network device or not according to the connectivity record linked to the MAC address or the BSSID of other WLAN network device having the same SSID as the current WLAN network device, or directly determine to connect to the current WLAN network device, or directly determine not to connect to the current WLAN network device, or pop up a message window on the screen to query the user, or others.

Based on the embodiments discussed above, poor user experience due to inefficient connection can be avoided.

The embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general-purpose hardware that is programmed using microcode or software to perform the functions recited above.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus capable of supporting cellular communications and wireless local area network (WLAN) communications, comprising:
a radio transceiver, configured to receive a beacon frame from a first network device, wherein the first network device is a WLAN network device which provides wireless communications service in a predetermined wireless local area network; and
a processor, configured to identify the first network device according to an identifier obtained from the beacon frame, and determine whether to connect to the first network device according to a connectivity record of the first network device or a usage scenario of the communications apparatus,
wherein if the processor determines that a WLAN connection to be established with the first network device will be an inefficient connection, the processor determines not to connect to the first network device.

2. The communications apparatus as claimed in claim 1, wherein if a cellular connection with a second network device has been established before receiving the beacon frame and the processor determines that the WLAN connection to be established with the first network device will be an inefficient connection, the processor determines not to connect to the first network device and maintains the cellular connection with the second network device.

3. The communications apparatus as claimed in claim 1, wherein the connectivity record of the first network device records a connection time of a previous WLAN connection measured when the communications apparatus previously connected to the first network device or an average connection time of the WLAN connections previously established with the first network device.

4. The communications apparatus as claimed in claim 1, wherein the connectivity record of the first network device records data throughput of a previous WLAN connection measured when the communications apparatus previously connected to the first network device or an average data throughput of the WLAN connections previously established with the first network device.

5. The communications apparatus as claimed in claim 1, wherein the connectivity record of the first network device records a connection quality of a previous WLAN connection measured when the communications apparatus previously connected to the first network device or an average connection quality of the WLAN connections previously established with the first network device.

6. The communications apparatus as claimed in claim 1, wherein the usage scenario is determined according to a moving speed of the communications apparatus.

7. The communications apparatus as claimed in claim 1, wherein the usage scenario is determined according to data throughput of a current cellular connection of the communications apparatus.

8. A method for avoiding establishing an inefficient wireless connection for a communications apparatus which is capable of supporting cellular communications and WLAN communications, comprising:
receiving a beacon frame from a first network device, wherein the first network device is a WLAN network device which provides wireless communications service in a predetermined wireless local area network;
identifying the first network device according to an identifier obtained from the beacon frame;
determining whether to connect to the first network device according to a connectivity record of the first network device or a usage scenario of the communications apparatus; and
not connecting to the first network device if a WLAN connection to be established with the first network device is determined as an inefficient connection.

9. The method as claimed in claim 8, wherein if a cellular connection with a second network device has been established before receiving the beacon frame, the method further comprises:
determining not to connect to the first network device and maintaining the cellular connection with the second network device if the WLAN connection to be established with the first network device is determined as an inefficient connection.

10. The method as claimed in claim 8, wherein the connectivity record of the first network device records a connection time of a previous WLAN connection measured when the communications apparatus previously connected to the first network device or an average connection time of the WLAN connections that the communications apparatus previously established with the first network device.

11. The method as claimed in claim 8, wherein the connectivity record of the first network device records data throughput of a previous WLAN connection measured when the communications apparatus previously connected to the first network device or an average data throughput of the WLAN connections that the communications apparatus previously established with the first network device.

12. The method as claimed in claim 8, wherein the connectivity record of the first network device records a connection quality of a previous WLAN connection measured when the communications apparatus previously connected to the first network device or an average connection quality of the WLAN connections that the communications apparatus previously established with the first network device.

13. The method as claimed in claim 8, wherein the usage scenario is determined according to a moving speed of the communications apparatus.

14. The method as claimed in claim 8, wherein the usage scenario is determined according to data throughput of a current cellular connection of the communications apparatus.
